(19) United States
(12) Patent Application Publication
(10) Pub. No.: US 2019/0312747 A1
(43) Pub. Date: Oct. 10, 2019

(54) METHOD, APPARATUS AND SYSTEM FOR CONTROLLING HOME DEVICE

(71) Applicant: Baidu Online Network Technology (Beijing) Co., Ltd., Beijing (CN)

(72) Inventors: Xiaobo Jia, Beijing (CN); Nan Wei, Beijing (CN); Hongwu Zhang, Beijing (CN)

(21) Appl. No.: 16/354,436

(22) Filed: Mar. 15, 2019

(30) Foreign Application Priority Data
Apr. 10, 2018 (CN) 201810315663.0

(51) Int. Cl. H04L 12/28; H04L 29/08; G06F 3/0488; G06F 3/01; G06F 3/0484; G05B 19/4155

(52) U.S. Cl. CPC H04L 12/2816; H04L 67/125; G06F 3/04886; G05B 2219/2642; G06F 3/04847; G05B 19/4155; G06F 3/017

(57) ABSTRACT

Embodiments of the present disclosure disclose a method, apparatus and system for controlling a home device. A specific implementation of the method includes: determining whether a current interaction between a user and a virtual control in a pre-built virtual scene meets a preset triggering condition, the virtual control corresponding to the home device being formed in the virtual scene; generating a control signal corresponding to the current interaction, in response to determining that the current interaction meets the preset triggering condition; transmitting the control signal to a control terminal, so that the control terminal controls the home device indicated by the control signal; receiving feedback information corresponding to the control signal transmitted by the control terminal; and rendering and displaying the virtual scene based on the feedback information.

### CROSS-REFERENCE TO RELATED APPLICATIONS

This application claims priority to Chinese Application No. 201810315663.0, filed on Apr. 10, 2018 and entitled “Method, Apparatus and System for Controlling Home Device,” the entire disclosure of which is hereby incorporated by reference.

### TECHNICAL FIELD

Embodiments of the present disclosure relate to the field of computer technology, and specifically to a method, apparatus and system for controlling a home device.

### BACKGROUND

Smart home (or home automation) generally integrates home life related facilities based on residential buildings using integrated wiring technology, network communication technology, security technology, automatic control technology, and audio and video technologies. Accordingly, smart home make it possible to build an efficient management system for residential facilities and family schedules. In turn, the home security, convenience, comfort and artistry may be improved, and an environmentally friendly and energy-saving living environment may be achieved.

Home intelligence technology originated in the United States, the most representative of which is the X-10 technology. Through the X-10 communication protocol, resources may be shared by various devices in a network system. Because of its simple wiring, flexible functions, and easy expansion, the X-10 technology is widely accepted and applied.

At present, the existing smart home control methods generally rely on pre-installed sensors or remote controllers to achieve control.

### SUMMARY

Embodiments of the present disclosure provide a method, apparatus and system for controlling a home device.

In a first aspect, the embodiments of the present disclosure provide a method for controlling a home device, including: determining whether a current interaction between a user and a virtual control in a pre-built virtual scene meets a preset triggering condition, the virtual control corresponding to the home device being formed in the virtual scene; generating a control signal corresponding to the current interaction, in response to determining that the current interaction meets the preset triggering condition; transmitting the control signal to a control terminal, so that the control terminal controls the home device indicated by the control signal; receiving feedback information corresponding to the control signal transmitted by the control terminal; and rendering and displaying the virtual scene based on the feedback information.

In some embodiments, the virtual control includes a virtual target area; and the determining whether a current interaction between a user and a virtual control in a pre-built virtual scene meets a preset triggering condition, includes: acquiring a current location of the user in the virtual scene, and determining whether the current location of the user is located in the virtual target area; and determining that the current interaction meets the preset triggering condition, in response to determining that the current location of the user is located in the virtual target area.

In some embodiments, the virtual control further includes a virtual target object; and the determining whether a current interaction between a user and a virtual control in a pre-built virtual scene meets a preset triggering condition, further includes: acquiring a current operation of the user in the virtual scene, and determining whether the current operation of the user touches the virtual target object; and determining that the current interaction meets the preset triggering condition, in response to determining that the current operation of the user touches the virtual target object.

In some embodiments, the generating a control signal corresponding to the current interaction, in response to determining that the current interaction meets the preset triggering condition, includes: acquiring a current state of the home device corresponding to the virtual control in the current interaction, in response to determining that the current interaction meets the preset triggering condition; and generating the control signal of the home device based on the acquired current state of the home device.

In some embodiment, the generating a control signal corresponding to the current interaction, in response to determining that the current interaction meets the preset triggering condition, includes: presenting a control interface in a preset area, in response to determining that the current interaction meets the preset triggering condition, where the control interface is used to adjust operating parameters of the home device corresponding to the virtual control in the current interaction; and generating the control signal of the home device corresponding to the virtual control in the current interaction, based on an operation of the user on the control interface.

In a second aspect, the embodiments of the present disclosure provide an apparatus for controlling a home device, including: a determination unit, configured to determine whether a current interaction between a user and a virtual control in a pre-built virtual scene meets a preset triggering condition, the virtual control corresponding to the home device being formed in the virtual scene; a generation unit, configured to generate a control signal corresponding to the current interaction, in response to determining that the current interaction meets the preset triggering condition; a transmitting unit, configured to transmit the control signal to a control terminal, so that the control terminal controls the home device indicated by the control signal; a receiving unit, configured to receive feedback information corresponding to the control signal transmitted by the control terminal; and a rendering unit, configured to render and display the virtual scene based on the feedback information.

In some embodiments, the virtual control includes a virtual target area; and the determination unit includes: a location acquisition subunit, configured to acquire a current location of the user in the virtual scene, and determine whether the current location of the user is located in the virtual target area; and a first responding subunit, configured to determine that the current interaction meets the preset triggering condition, in response to determining that the current location of the user is located in the virtual target area.

In some embodiments, the virtual control further includes a virtual target object; and the determination unit further includes: an operation acquisition subunit, configured to acquire a current operation of the user in the virtual scene, and determine whether the current operation of the user touches the virtual target object; and a second responding subunit, configured to determine that the current interaction meets the preset triggering condition, in response to determining that the current operation of the user touches the virtual target object.

In some embodiments, the generation unit is further configured to: acquire a current state of the home device corresponding to the virtual control in the current interaction, in response to determining that the current interaction meets the preset triggering condition; and generate the control signal of the home device based on the acquired current state of the home device.

In some embodiments, the generation unit is further configured to: present a control interface in a preset area, in response to determining that the current interaction meets the preset triggering condition, where the control interface is used to adjust operating parameters of the home device corresponding to the virtual control in the current interaction; and generate the control signal of the home device corresponding to the virtual control in the current interaction, based on an operation of the user on the control interface.

In a third aspect, the embodiments of the present disclosure provide a system for controlling a home device, including: a terminal and a control terminal. A pre-built virtual scene is displayed on a display screen of the terminal, and the virtual scene has a virtual control corresponding to the home device; the terminal, is configured to determine whether a current interaction between a user and the virtual control in the virtual scene meets a preset triggering condition; generate a control signal corresponding to the current interaction, and transmit the control signal to the control terminal, in response to determining that the current interaction meets the preset triggering condition; receive feedback information corresponding to the control signal transmitted by the control terminal; and render and display the virtual scene based on the feedback information; and the control terminal, is configured to control the home device indicated by the control signal transmitted by the terminal; and return the feedback information corresponding to the control signal.

In some embodiments, the virtual control includes a virtual target area; and the terminal is further configured to: acquire a current location of the user in the virtual scene, and determine whether the current location of the user is located in the virtual target area; and determine that the current interaction meets the preset triggering condition, in response to determining that the current location of the user is located in the virtual target area.

In some embodiments, the virtual control further includes a virtual target object; and the terminal is further configured to: acquire a current operation of the user in the virtual scene, and determine whether the current operation of the user touches the virtual target object; and determine that the current interaction meets the preset triggering condition, in response to determining that the current operation of the user touches the virtual target object.

In some embodiments, the terminal is further configured to: acquire a current state of the home device corresponding to the virtual control in the current interaction, in response to determining that the current interaction meets the preset triggering condition; and generate the control signal of the home device based on the acquired current state of the home device; or present a control interface in a preset area, in response to determining that the current interaction meets the preset triggering condition, where the control interface is used to adjust operating parameters of the home device corresponding to the virtual control in the current interaction; and generate the control signal of the home device corresponding to the virtual control in the current interaction, based on an operation of the user on the control interface.

In a fourth aspect, the embodiments of the present disclosure provide an electronic device, including: one or more processors; a display screen, configured to display an image; a storage apparatus, storing one or more programs thereon; and the one or more programs, when executed by the one or more processors, cause the one or more processors to implement the method according to any one of the embodiments in the first aspect.

In a fifth aspect, the embodiments of the present disclosure provide a computer readable medium, storing a computer program thereon, the computer program, when executed by a processor, implements the method according to any one of the embodiments in the first aspect.

The method, apparatus and system for controlling a home device provided by the embodiments of the present disclosure determine whether a current interaction between a user and a virtual control in a pre-built virtual scene meets a preset triggering condition, and generate a control signal corresponding to the current interaction, in response to determining that the current interaction meets the preset triggering condition. Further, the control signal may be transmitted to a control terminal, so that the control terminal controls the home device indicated by the control signal. In this regard, the control of the home device may be realized to help to increase the flexibility of the control. In addition, feedback information corresponding to the control signal transmitted by the control terminal may also be received, and further the virtual scene may be rendered and displayed based on the feedback information. In this way, the effect produced by controlling the home device may be simulated and displayed, and the control effect may be visualized to improve the user experience.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is an architectural diagram of an exemplary system in which the present disclosure may be implemented;

FIG. 2 is a flowchart of an embodiment of a method for controlling a home device according to the present disclosure;

FIG. 3 is a schematic diagram of an application scenario of the method for controlling a home device according to the present disclosure;

FIG. 4 is a schematic structural diagram of an embodiment of an apparatus for controlling a home device according to the present disclosure;

FIG. 5 is a timing diagram of an embodiment of a system for controlling a home device according to the present disclosure; and

FIG. 6 is a schematic structural diagram of a computer system adapted to implement an electronic device of the embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

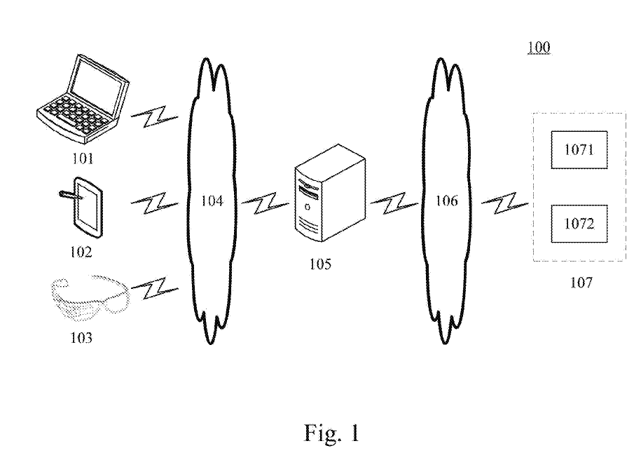

FIG. 1 illustrates an exemplary architecture of a system 100 in which a method, apparatus, or system for controlling a home device to which the embodiments of the present disclosure may be implemented.

As shown in FIG. 1, the system architecture 100 may include terminal devices 101, 102, 103, networks 104, 106, a server 105 and a home device 107. The network 104 may be configured to provide a communication link medium between the terminal devices 101, 102, 103 and the server 105. The network 106 may be configured to provide a communication link medium between the server 105 and the home device 107. The networks 104, 106 may include various types of connections, such as wired, wireless communication links, or optical fibers.

The user may use the terminals 101, 102, 103 to interact with the server 105 via the network 104 to receive or send messages or the like. The terminals 101, 102, and 103 may be installed with various client applications, such as a smart home control system, an AR (Augmented Reality) application, a web browser, and an instant messaging tool.

The terminals 101, 102, 103 may acquire current interaction data between the user and an application installed thereon, so that the current interaction data may be analyzed and processed, and the processing result (such as the generated control signal) may be sent to the server 105. In this way, the server 105 may control the corresponding home device based on the processing result.

The terminals 101, 102 and 103 may be hardware or software. When the terminals 101, 102 and 103 are hardware, they may be various electronic devices having display screens, including but not limited to smart phones, tablets, AR glasses or helmets, e-book readers, and MP3 players (Moving Picture Experts Group Audio Layer III), laptop portable computers, desktop computers, etc. When the terminals 101, 102 and 103 are software, they may be installed in the above-listed electronic devices. They may be implemented as a plurality of software or software modules (e.g., to provide distributed services) or as a single software or software module, which is not specifically limited in the present disclosure.

The server 105 may be a server that provides various services, such as a control server that controls the home device. The control server may receive and analyze control signals transmitted by the terminals 101, 102, and 103, and then control the home device indicated by the control signals. In addition, the control server may return a control result (such as feedback information) to the terminals 101, 102, 103. In this way, the terminals 101, 102, 103 may present the control result to the user.

The server 105 here may also be hardware or software. When the server 105 is hardware, it may be implemented as a distributed server cluster composed of a plurality of servers, or may be implemented as a single server. When the server 105 is software, it may be implemented as a plurality of software or software modules (for example, for providing distributed services), or as a single software or software module, which is not specifically limited in the present disclosure.

The home device 107 may include at least one home device, such as home devices 1071, 1072. The home device 107 may be various devices required in daily family life, including but not limited to home appliances (such as air conditioners, refrigerators, televisions), lighting equipments, security equipments (such as access controls, monitors), and kitchen and bathroom equipments (such as rice cookers, water heater) and so on.

It should be noted that the method for controlling a home device provided by the embodiment of the present disclosure is generally performed by the terminals 101, 102, and 103. Accordingly, the apparatus for controlling a home device is generally provided in the terminals 101, 102, 103.

It should be appreciated that the numbers of the terminals, the networks, the servers and the home devices in FIG. 1 are merely illustrative. Any number of terminals, networks, servers and home devices may be provided based on the actual requirements.

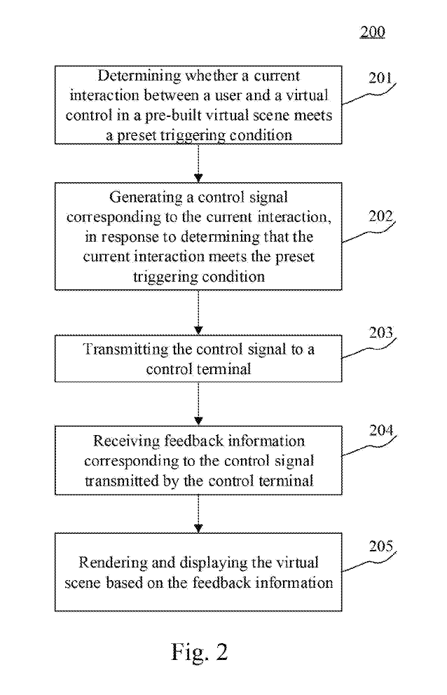

With further reference to FIG. 2, a flow 200 of an embodiment of a method for controlling a home device according to the present disclosure is illustrated. The method for controlling a home device may include the following steps.

Step 201, determining whether a current interaction between a user and a virtual control in a pre-built virtual scene meets a preset triggering condition.

In the present embodiment, an execution body of the method for controlling a home device (for example, the terminals 101, 102 and 103 as shown in FIG. 1) may determine whether a current interaction between a user and a virtual control in a pre-built virtual scene meets a preset triggering condition by using various methods. Here, a virtual control corresponding to the home device (for example, the home device 107 as shown in FIG. 1) may be formed in the virtual scene. The virtual scene here may be any scene, such as a fictional scene or a scene simulating a real environment. At the same time, the virtual control may be any operable part in the virtual scene. Here, the operation on the virtual control in the virtual scene may be characterized as an operation on the home device in real life.

In the present embodiment, the execution body may build the virtual scene in a plurality of methods. For example, the execution body may acquire an existing sample virtual scene; then, the virtual control may be constructed in the sample virtual scene to generate a required virtual scene.

For another example, the execution body may acquire an existing sample image; after that, a sample virtual scene of the sample image may be generated; then, the virtual control may be constructed in the generated sample virtual scene to generate a required virtual scene. The sample image may be a depth image (i.e., an image containing depth information) or a planar image. The sample image may be a color image or a grayscale image. The image format thereof is not limited in the present disclosure as long as it may be recognized and read by the execution body.

As an example, the execution body may also utilize an image acquisition device (such as a camera) installed thereon to collect environmental information of the surrounding environment (such as a living room, or a bedroom). Then, a virtual environment scene of the surrounding environment may be built. Next, the above virtual control is built in the virtual environment scene to generate a required virtual scene.

It should be noted that the execution body may also build the above virtual control in various methods. For example, the virtual control is formed by using a template provided in the software program, and the corresponding relationship between the virtual control and the home device may be customized. Further, for example, an image of the home device is used to build a virtual mapping of the home device to form a virtual control corresponding to the home device. Here, the image of the home device may be obtained by collecting the home device by using an image acquisition device installed on the execution body, or may be acquired from an existing image database.

In the present embodiment, the preset triggering condition may be used to characterize the current interaction behavior for performing home device control. The preset triggering condition may be set according to the actual situation.

In some alternative implementations of the present disclosure, the virtual control may include a virtual target area. Here, the virtual target area may be any area in the virtual scene set by the user. In this case, the execution body may acquire a current location of the user in the virtual scene, and determine whether the current location of the user is located in the virtual target area. For example, SLAM (simultaneous localization and mapping) technology may be used to locate the current location of the user in the virtual scene in real time during the user's moving process. Alternatively, the GPS (Global Positioning System) technology or the like may be used to determine the current location of the terminal in real life, that is, the current location of the user in real life. In turn, the current location of the user in real life may be converted to the current location of the user in the virtual scene. In this way, if it is determined that the current location of the user is located in the virtual target area, the current interaction may be determined to meet the preset triggering condition. That is, the preset triggering condition may be that the current location of the user in the virtual scene is located in the virtual target area.

Alternatively, the virtual control may further include a virtual target object. In this case, the execution body may acquire a current operation of the user in the virtual scene, and determine whether the current operation of the user touches the virtual target object. If it is determined that the current operation of the user touches the virtual target object, the current interaction may be determined to meet the preset triggering condition. That is, the preset triggering condition may also be that the current operation of the user in the virtual scene touches the virtual target object.

The operation here may be either a real operation or virtual operation. Therefore, the touch on the virtual target object here may be a contact click touch or a non-contact touch. For example, the click position of the user on the display screen may be obtained to determine whether the virtual object corresponding to the click position is the virtual target object. If the virtual object corresponding to the click position is the virtual target object, it may be determined that the current operation of the user touches the virtual target object. For another example, an operation gesture or a motion trajectory of the eyes of the user may be acquired to determine whether the user's operation gesture is currently pointing to the virtual target object, or whether the user's eyes are currently looking at the virtual target object. If the user's operation gesture is pointing to the virtual target object or the user's eyes are looking at the virtual target object, it may be determined that the current operation of the user touches the virtual target object.

In some application scenarios, in order to enrich the interaction and improve the convenience of the operation, the interaction here may also include speech interaction. In this case, the execution body may receive a speech operation instruction of the user. By analyzing and recognizing the speech operation instruction, whether the speech operation instruction is used to characterize an operation on the virtual control may be determined. If it is determined that the speech operation instruction is an operation on the virtual control, it may be determined that the current interaction meets the preset triggering condition.

Step 202, generating a control signal corresponding to the current interaction, in response to determining that the current interaction meets the preset triggering condition.

In the present embodiment, based on the determination result in step 201, if the execution body determines that the current interaction meets the preset triggering condition, a control signal corresponding to the current interaction may be generated. Here, the control signal may be a signal for indicating control on the home device. The control signal may include, but is not limited to, an identifier of the home device to be controlled. The identifier here may be the name, model number, postal address, etc. of the home device to be controlled.

In some alternative implementations of the present disclosure, a control list may be stored in advance in the execution body. Here, the control list may be used to describe a corresponding relationship between the virtual control and control information. For example, the identifier and/or control parameters of the home device corresponding to the virtual target area and/or the virtual target object may be stored in the control list. Here, the control parameters may be operating parameters of the home device, such as a program or channel played after the television is turned on. In this way, the execution body may find the control information corresponding to the virtual control in the current interaction in the control list, thereby generating a control signal.

Alternatively, in order to improve the flexibility of the control, in the case that it is determined that the current interaction meets the preset triggering condition, the execution body may first acquire a current state of the home device corresponding to the virtual control in the current interaction. Then, the execution body may generate the control signal of the home device based on the acquired current state of the home device. For example, when the user touches the virtual target object, if the home device corresponding to the virtual target object is currently in a closed state, a control signal for opening the home device may be generated. For some home devices with adjustable operating parameters, the control signal here may also include operating parameters set after the home device is turned on, such as the operating temperature and air speed of the air conditioner. If the home device is currently on, a control signal may be generated to turn off the home device. In this regard, it may enable switch control of the home device, which helps to increase the flexibility and applicability of the control.

It should be noted that the execution body may acquire the current state of the home device from a control terminal (for example, the server 105 as shown in FIG. 1). Alternatively, the execution body may also acquire the current state of the home device from operation state information of each home device stored locally. The acquisition method is not limited in the present disclosure.

To further increase the flexibility of the control, the execution body may further determine whether the current interaction with the virtual control conforms to a preset operation while the home device is currently on. If it is determined that the current interaction conforms to the preset operation, a control interface may be presented in a preset area. Here, the control interface may be used to adjust operating parameters of the home device corresponding to the virtual control in the current interaction. The preset operation, preset area and control interface here may be set according to actual conditions. For example, the preset operation may be 3 seconds for the interaction time. The preset area may be the location of the virtual control in the current interaction. The control interface is usually associated with the corresponding home device. That is, the control interfaces of different home devices are often different. In this case, not only the switch control of the home device but also the real-time adjustment of the operating parameters of the home device during operation may be realized. In this way, for the home device with adjustable operating parameters, the operating parameters of the home device may also be dynamically adjusted according to actual needs without modifying the preset operating parameters. This in turn helps to increase the flexibility and convenience of operating control.

In some application scenarios, if the execution body determines that the current interaction meets the preset triggering condition, a control interface may be presented directly in a preset area. Here, the preset area and the control interface may be the same as the foregoing preset area and the foregoing control interface, and detailed descriptions thereof will be omitted. In addition, the control interface here may also be used to control the on/off state of the home device. In this regard, based on an operation of the user on the control interface, the control signal of the home device corresponding to the virtual control in the current interaction may be generated.

Further, in the case that the interaction is speech interaction, the execution body may recognize the speech operation instruction of the user, thereby generating a control signal corresponding to the current interaction based on the recognition result. This may help improve control efficiency and reduce waiting time of the user.

Step 203, transmitting the control signal to a control terminal.

In the present embodiment, the execution body may transmit the control signal generated in step 202 to a control terminal (for example, the server 105 as shown in FIG. 1) through a wired connection or a wireless connection. The control terminal here may be a common control terminal (such as a home gateway) for controlling all of the home devices. The control terminal here may also be control terminals used to control each of the home devices (for example, controllers of each of the home devices), respectively. In this case, the execution body may transmit the control signal to the control terminal that controls the home device indicated by the control signal. In this way, the control terminal may adjust the on-off state and/or operating parameters of the corresponding home device according to the control signal.

Step 204, receiving feedback information corresponding to the control signal transmitted by the control terminal.

In the present embodiment, the control terminal may generate feedback information after performing control adjustment on the home device. The feedback information may be transmitted to the execution body. The feedback information here may be used to describe the control result of the home device indicated by the control signal. For example, the feedback information may include whether the control is successful and the operating state of the home device after the control is successful. In this case, the execution body may also receive the feedback information corresponding to the control signal transmitted by the control terminal through a wired connection or a wireless connection.

It may be understood that when the execution body receives the feedback information from the control terminal, the execution body may acquire the current state of the home device indicated by the feedback information. Alternatively, the execution body may store the operating state information of each home device. In addition, the current state of the home device stored on the execution body may be updated based on the feedback information.

Step 205, rendering and displaying the virtual scene based on the feedback information.

In the present embodiment, based on the feedback information received in step 204, the execution body may render the virtual scene. In addition, the execution body may display the rendered virtual scene. For example, a rendering list may also be stored in advance in the execution body. The rendering list may be used to describe a corresponding relationship between the feedback information and rendering setting parameters. In this way, the execution body may find the rendering setting parameters corresponding to the feedback information in the rendering list, thus the rendering of the virtual scene is performed based on the rendering setting parameters. Here, the rendering method may include (but not limited to) sound rendering, optoelectronic rendering, or dynamic effect rendering. For example, when the feedback information indicates that the light is turned on, an analog sound of turning on the switch may be played at this time, meanwhile the light and the surrounding environment in the virtual scene may be brightened. In addition, in order to increase the sense of reality of the rendering effect, it is also possible to form a shadow on the backlight surface of the object in the virtual scene.

It should be noted that, in the method for controlling a home device in the present embodiment, the user may customize the virtual control, the triggering condition, and the rendering effect setting, etc., which helps to improve the flexibility and application range of the control method. At the same time, the control result may be simulated and displayed, which is beneficial to enhance the user experience.

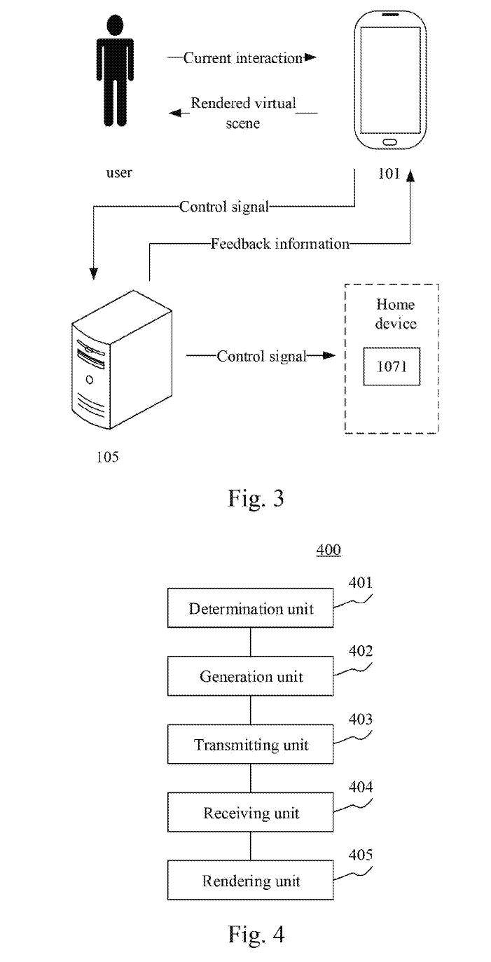

With further reference to FIG. 3, FIG. 3 is a schematic diagram of an application scenario of the method for controlling a home device according to the present embodiment. In the application scenario of FIG. 3, the user may control the home device in the home using a control application installed on the terminal 101. When the user opens the control application, a pre-built home virtual scene may be displayed on the display screen of the terminal 101. The virtual control corresponding to each home device in the home is formed in the home virtual scene. Then, the terminal 101 may acquire the current interaction between the user and the virtual control in the home virtual scene in real time. And when the current interaction meets the preset triggering condition, a control signal corresponding to the current interaction may be generated. Then, the terminal 101 may transmit the control signal to the server 105.

After receiving the control signal, the server 105 may control the home device (such as a home device 1071) indicated by the control signal. And based on the control result, the server 105 may generate corresponding feedback information, and transmit the feedback information to the terminal 101.

At this time, the terminal 101 may render the home virtual scene based on the feedback information. The rendered home virtual scene may be presented to the user.

The method for controlling a home device provided by the present embodiment determines whether a current interaction between a user and a virtual control in a pre-built virtual scene meets a preset triggering condition, and generates a control signal corresponding to the current interaction in response to determining that the current interaction meets the preset triggering condition. Further, the control signal may be transmitted to a control terminal, so that the control terminal controls the home device indicated by the control signal. In this regard, the control of the home device may be realized to help to increase the flexibility of the control. In addition, feedback information corresponding to the control signal transmitted by the control terminal may also be received, and further the virtual scene may be rendered and displayed based on the feedback information. In this way, the effect produced by controlling the home device may be simulated and displayed, and the control effect may be visualized to improve the user experience.

With further reference to FIG. 4, as an implementation to the method shown in the above figures, the present disclosure provides an embodiment of an apparatus for controlling a home device. The apparatus embodiment corresponds to the method embodiment shown in the above embodiments, and the apparatus may specifically be applied to various electronic devices.

As shown in FIG. 4, the apparatus 400 for controlling a home device of the present embodiment may include: a determination unit 401, configured to determine whether a current interaction between a user and a virtual control in a pre-built virtual scene meets a preset triggering condition, the virtual control corresponding to the home device being formed in the virtual scene; a generation unit 402, configured to generate a control signal corresponding to the current interaction, in response to determining that the current interaction meets the preset triggering condition; a transmitting unit 403, configured to transmit the control signal to a control terminal, so that the control terminal controls the home device indicated by the control signal; a receiving unit 404, configured to receive feedback information corresponding to the control signal transmitted by the control terminal; and a rendering unit 405, configured to render and display the virtual scene based on the feedback information.

In some alternative implementations of the present embodiment, the virtual control may include a virtual target area; and the determination unit 401 may include: a location acquisition subunit (not shown in FIG. 4), configured to acquire a current location of the user in the virtual scene, and determine whether the current location of the user is located in the virtual target area; and a first responding subunit (not shown in FIG. 4), configured to determine that the current interaction meets the preset triggering condition, in response to determining that the current location of the user is located in the virtual target area.

Alternatively, the virtual control may further include a virtual target object; and the determination unit 401 may further include: an operation acquisition subunit (not shown in FIG. 4), configured to acquire a current operation of the user in the virtual scene, and determine whether the current operation of the user touches the virtual target object; and a second responding subunit (not shown in FIG. 4), configured to determine that the current interaction meets the preset triggering condition, in response to determining that the current operation of the user touches the virtual target object.

In some embodiments, the generation unit 402 may be further configured to: acquire a current state of the home device corresponding to the virtual control in the current interaction, in response to determining that the current interaction meets the preset triggering condition; and generate the control signal of the home device based on the acquired current state of the home device.

Further, the generation unit 402 may be further configured to: present a control interface in a preset area, in response to determining that the current interaction meets the preset triggering condition, where the control interface is used to adjust operating parameters of the home device corresponding to the virtual control in the current interaction; and generate the control signal of the home device corresponding to the virtual control in the current interaction, based on an operation of the user on the control interface.

It may be understood that the units described in the apparatus 400 correspond to the various steps in the method described with reference to FIG. 2. Thus, the operations, features, and resulting beneficial effects described above for the method are equally applicable to the apparatus 400 and the units contained therein, and detailed descriptions thereof will be omitted.

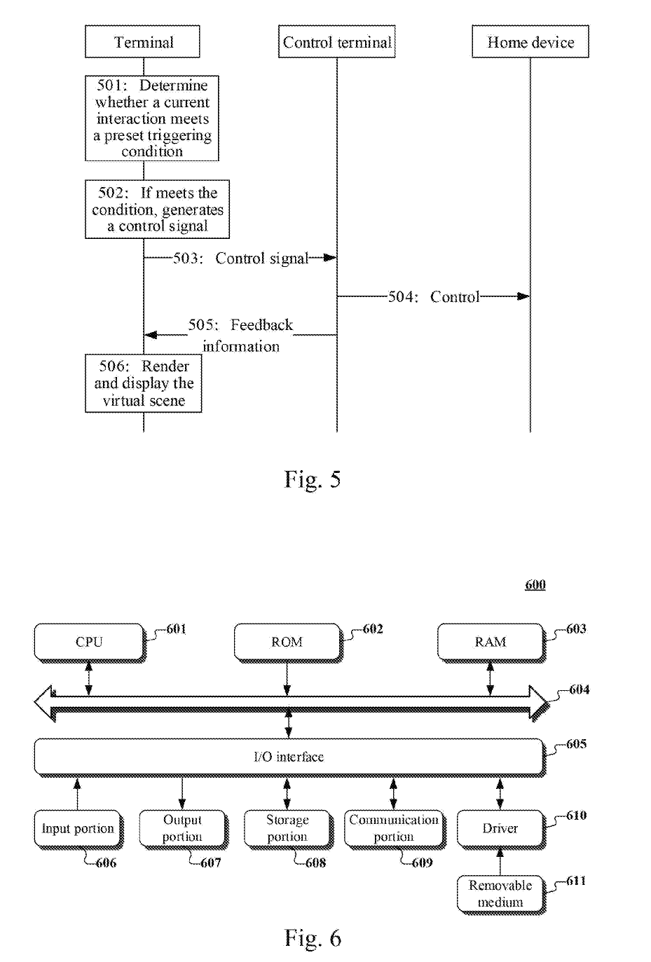

With further reference to FIG. 5, a timing diagram of a system for controlling a home device according to the present disclosure is illustrated.

The system for controlling a home device of the present embodiment may include a terminal and a control terminal. A pre-built virtual scene is displayed on a display screen of the terminal, and the virtual scene has a virtual control corresponding to the home device; the terminal, is configured to determine whether a current interaction between a user and the virtual control in the virtual scene meets a preset triggering condition; generate a control signal corresponding to the current interaction, and transmit the control signal to the control terminal, in response to determining that the current interaction meets the preset triggering condition; receive feedback information corresponding to the control signal transmitted by the control terminal; and render and display the virtual scene based on the feedback information; and the control terminal, is configured to control the home device indicated by the control signal transmitted by the terminal; and return the feedback information corresponding to the control signal.

As shown in FIG. 5, in step 501, the terminal may determine whether a current interaction between the user and the virtual control in the virtual scene meets a preset triggering condition.

In the present embodiment, the terminal (for example, the terminals 101, 102 and 103 as shown in FIG. 1) may determine whether a current interaction between a user and a virtual control in a pre-built virtual scene meets a preset triggering condition by using various methods. Here, a virtual control corresponding to the home device (for example, the home device 107 as shown in FIG. 1) may be formed in the virtual scene. The virtual scene here may be any scene, such as a fictional scene or a scene simulating a real environment. At the same time, the virtual control may be any operable part in the virtual scene. Here, the operation on the virtual control in the virtual scene may be characterized as an operation on the home device in real life.

In the present embodiment, the terminal may build the virtual scene and the virtual control in a plurality of methods. In addition, the preset triggering condition may be used to characterize the current interaction behavior for performing home device control. The preset triggering condition may be set according to the actual situation. For details, reference may be specifically made to the related description in step 201 of the embodiment in FIG. 2, and detailed description thereof will be omitted.

In some alternative implementations of the present disclosure, the virtual control may include a virtual target area. At this time, the terminal may acquire a current location of the user in the virtual scene, and determine whether the current location of the user is located in the virtual target area; and determine that the current interaction meets the preset triggering condition, in response to determining that the current location of the user is located in the virtual target area.

Alternatively, the virtual control may further include a virtual target object. At this time, the terminal may also acquire a current operation of the user in the virtual scene, and determine whether the current operation of the user touches the virtual target object; and determine that the current interaction meets the preset triggering condition, in response to determining that the current operation of the user touches the virtual target object.

In step 502, if the terminal determines that the current interaction meets the preset triggering condition, the control signal corresponding to the current interaction may be generated.

In the present embodiment, in response to determining that the current interaction meets the preset triggering condition, the terminal may generate a control signal corresponding to the current interaction. Here, the control signal may be a signal for indicating control of the home device. The control signal may include, but is not limited to, an identifier of the home device to be controlled. The identifier here may be the name, model number, postal address, etc. of the home device to be controlled. Here, the specific method for generating a control signal may be referred to in the related description in step 202 of the embodiment in FIG. 2, and detailed description thereof will be omitted.

In some alternative implementations of the present disclosure, in response to determining that the current interaction meets the preset triggering condition, the terminal may further acquire a current state of the home device corresponding to the virtual control in the current interaction, and generate the control signal of the home device based on the acquired current state of the home device.

Alternatively, in response to determining that the current interaction meets the preset triggering condition, the terminal may present a control interface in a preset area. Here, the control interface may be used to adjust operating parameters of the home device corresponding to the virtual control in the current interaction, and generate the control signal of the home device corresponding to the virtual control in the current interaction, based on an operation of the user on the control interface.

In step 503, the terminal may transmit the control signal to the control terminal.

In the present embodiment, the terminal may transmit the control signal to the control terminal (for example, the server 105 as shown in FIG. 1) through a wired connection or a wireless connection. The control terminal here may be a common control terminal (such as a home gateway) for controlling all of the home devices. The control terminal here may also be control terminals used to control each of the home devices (for example, controllers of each of the home devices), respectively.

In step 504, the control terminal may control the home device indicated by the control signal transmitted by the terminal.

In the present embodiment, after receiving the control signal transmitted by the terminal, the control terminal may control the home device indicated by the control signal through a wired connection or a wireless connection, that is, perform a control operation. The wireless connection here may include, but is not limited to, Bluetooth, WiFi (Wireless Fidelity), ZigBee (Zifeng Protocol) and the like.

In step 505, the control terminal may return feedback information corresponding to the control signal to the terminal.

In the present embodiment, the control terminal may generate feedback information after performing control adjustment on the home device, and may transmit the feedback information to the terminal through a wired connection or a wireless connection. The feedback information here may be used to describe the control result of the home device indicated by the control signal. For example, the feedback information may include whether the control is successful and the operating state of the home device after the control is successful.

In step 506, the terminal renders and displays the virtual scene based on the feedback information.

In the present embodiment, the terminal may render the virtual scene based on the feedback information transmitted by the control terminal, and may display the rendered virtual scene. For details, reference may be specifically made to the related description in step 205 of the embodiment in FIG. 2, and detailed description thereof will be omitted.

The system for controlling a home device provided by the present embodiment determines whether a current interaction between a user and a virtual control in a pre-built virtual scene meets a preset triggering condition, and generates a control signal corresponding to the current interaction in response to determining that the current interaction meets the preset triggering condition. Further, the control signal may be transmitted to a control terminal, so that the control terminal controls the home device indicated by the control signal. In this regard, the control of the home device may be realized to help to increase the flexibility of the control. In addition, the control terminal may transmit feedback information corresponding to the control signal to the terminal, and further the terminal may render and display the virtual scene based on the feedback information. In this way, the effect produced by controlling the home device may be simulated and displayed, and the control effect may be visualized to improve the user experience.

Referring to FIG. 6, a schematic structural diagram of a computer system 600 adapted to implement an electronic device (for example, the terminals 101, 102 and 103 as shown in FIG. 1) of the embodiments of the present disclosure is shown. The electronic device shown in FIG. 6 is merely an example, and should not limit the function and scope of use of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a touch screen, a keyboard, a voice receiving device, a camera device, etc.; an output portion 607 including such as a cathode ray tube (CRT), a liquid crystal display device (LCD), a speaker, etc.; a storage portion 608 including a hard disk and the like; and a communication portion 609 including a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for executing the method as illustrated in the flow chart. In such an embodiment, the computer program may be downloaded and installed from a network via the communication portion 609, and/or may be installed from the removable medium 611. The computer program, when executed by the central processing unit (CPU) 601, implements the above mentioned functionalities as defined by the method of the present disclosure. It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor, for example, described as: a processor, including a determination unit, a generation unit, a transmitting unit, a receiving unit and a rendering unit. Here, the names of these units do not in some cases constitute a limitation to such units themselves. For example, the determination unit may also be described as “a unit for determining whether a current interaction between a user and a virtual control in a pre-built virtual scene meets a preset triggering condition.”

In another aspect, the present disclosure further provides a computer readable medium. The computer readable medium may be included in the electronic device in the above described embodiments, or a stand-alone computer readable medium not assembled into the electronic device. The computer readable medium carries one or more programs. The one or more programs, when executed by the electronic device, cause the electronic device to: determine whether a current interaction between a user and a virtual control in a pre-built virtual scene meets a preset triggering condition, the virtual control corresponding to the home device being formed in the virtual scene; generate a control signal corresponding to the current interaction, in response to determining that the current interaction meets the preset triggering condition; transmit the control signal to a control terminal, so that the control terminal controls the home device indicated by the control signal; receive feedback information corresponding to the control signal transmitted by the control terminal; and render and display the virtual scene based on the feedback information.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

What is claimed is:

1. A method for controlling a home device, the method comprising:
determining whether a current interaction between a user and a virtual control in a pre-built virtual scene meets a preset triggering condition, the virtual control corresponding to the home device being formed in the virtual scene;
generating a control signal corresponding to the current interaction, in response to determining that the current interaction meets the preset triggering condition;
transmitting the control signal to a control terminal, so that the control terminal controls the home device indicated by the control signal;
receiving feedback information corresponding to the control signal transmitted by the control terminal; and
rendering and displaying the virtual scene based on the feedback information.

2. The method according to claim 1, wherein the virtual control comprises a virtual target area; and
the determining whether a current interaction between a user and a virtual control in a pre-built virtual scene meets a preset triggering condition, comprises:
acquiring a current location of the user in the virtual scene, and determining whether the current location of the user is located in the virtual target area; and
determining that the current interaction meets the preset triggering condition, in response to determining that the current location of the user is located in the virtual target area.

3. The method according to claim 1, wherein the virtual control further comprises a virtual target object; and
the determining whether a current interaction between a user and a virtual control in a pre-built virtual scene meets a preset triggering condition, further comprises:
acquiring a current operation of the user in the virtual scene, and determining whether the current operation of the user touches the virtual target object; and
determining that the current interaction meets the preset triggering condition, in response to determining that the current operation of the user touches the virtual target object.

4. The method according to claim 1, wherein the generating a control signal corresponding to the current interaction, in response to determining the current interaction meets the preset triggering condition, comprises:
acquiring a current state of the home device corresponding to the virtual control in the current interaction, in response to determining that the current interaction meets the preset triggering condition; and
generating the control signal of the home device based on the acquired current state of the home device.

5. The method according to claim 1, wherein the generating a control signal corresponding to the current interaction, in response to determining that the current interaction meets the preset triggering condition, comprises:
presenting a control interface in a preset area, in response to determining the current interaction meets the preset triggering condition, wherein the control interface is used to adjust operating parameters of the home device corresponding to the virtual control in the current interaction; and
generating the control signal of the home device corresponding to the virtual control in the current interaction, based on an operation of the user on the control interface.

6. An apparatus for controlling a home device, the apparatus comprising:
at least one processor; and
a memory storing instructions, the instructions when executed by the at least one processor, cause the at least one processor to perform operations, the operations comprising:
determining whether a current interaction between a user and a virtual control in a pre-built virtual scene meets a preset triggering condition, the virtual control corresponding to the home device being formed in the virtual scene;
generating a control signal corresponding to the current interaction, in response to determining that the current interaction meets the preset triggering condition;
transmitting the control signal to a control terminal, so that the control terminal controls the home device indicated by the control signal;
receiving feedback information corresponding to the control signal transmitted by the control terminal; and
rendering and displaying the virtual scene based on the feedback information.

7. The apparatus according to claim 6, wherein the virtual control comprises a virtual target area; and
the determining whether a current interaction between a user and a virtual control in a pre-built virtual scene meets a preset triggering condition, comprises:
acquiring a current location of the user in the virtual scene, and determining whether the current location of the user is located in the virtual target area; and
determining that the current interaction meets the preset triggering condition, in response to determining that the current location of the user is located in the virtual target area.

8. The apparatus according to claim 6, wherein the virtual control further comprises a virtual target object; and
the determining whether a current interaction between a user and a virtual control in a pre-built virtual scene meets a preset triggering condition, further comprises:
acquiring a current operation of the user in the virtual scene, and determining whether the current operation of the user touches the virtual target object; and
determining that the current interaction meets the preset triggering condition, in response to determining that the current operation of the user touches the virtual target object.

9. The apparatus according to claim 6, wherein the generating a control signal corresponding to the current interaction, in response to determining the current interaction meets the preset triggering condition, comprises:
acquiring a current state of the home device corresponding to the virtual control in the current interaction, in response to determining that the current interaction meets the preset triggering condition; and
generating the control signal of the home device based on the acquired current state of the home device.

10. The apparatus according to claim 6, wherein the generating a control signal corresponding to the current interaction, in response to determining that the current interaction meets the preset triggering condition, comprises:
presenting a control interface in a preset area, in response to determining that the current interaction meets the preset triggering condition, wherein the control interface is used to adjust operating parameters of the home device corresponding to the virtual control in the current interaction; and
generating the control signal of the home device corresponding to the virtual control in the current interaction, based on an operation of the user on the control interface.

11. A system for controlling a home device, comprising a terminal and a control terminal, wherein a pre-built virtual scene is displayed on a display screen of the terminal, and the virtual scene has a virtual control corresponding to the home device;
the terminal, is configured to determine whether a current interaction between a user and the virtual control in the virtual scene meets a preset triggering condition; generate a control signal corresponding to the current interaction, and transmit the control signal to the control terminal, in response to determining that the current interaction meets the preset triggering condition; receive feedback information corresponding to the control signal transmitted by the control terminal; and render and display the virtual scene based on the feedback information;
the control terminal, is configured to control the home device indicated by the control signal transmitted by the terminal; and return the feedback information corresponding to the control signal.

12. The system according to claim 11, wherein the virtual control comprises a virtual target area; and
the terminal is further configured to:
acquire a current location of the user in the virtual scene, and determine whether the current location of the user is located in the virtual target area; and
determine that the current interaction meets the preset triggering condition, in response to determining that the current location of the user is located in the virtual target area.

13. The system according to claim 11, wherein the virtual control further comprises a virtual target object; and
the terminal is further configured to:
acquire a current operation of the user in the virtual scene, and determine whether the current operation of the user touches the virtual target object; and
determine that the current interaction meets the preset triggering condition, in response to determining that the current operation of the user touches the virtual target object.

14. The system according to claim 11, wherein the terminal is further configured to:
acquire a current state of the home device corresponding to the virtual control in the current interaction, in response to determining that the current interaction meets the preset triggering condition; and generate the control signal of the home device based on the acquired current state of the home device; or
present a control interface in a preset area, in response to determining that the current interaction meets the preset triggering condition, wherein the control interface is used to adjust operating parameters of the home device corresponding to the virtual control in the current interaction; and generate the control signal of the home device corresponding to the virtual control in the current interaction, based on an operation of the user on the control interface.
